(19) United States
(12) Patent Application Publication
(10) Pub. No.: US 2013/0204625 A1
(43) Pub. Date: Aug. 8, 2013

(54) EXERCISE AND LEARNING CONCEPT USING AN EXERCISE AND LEARNING DEVICE FOR THE THERAPEUTIC TREATMENT OF PATIENTS IN THE MEDICAL DOMAIN

(71) Applicant: Hermann Aicher, Olching (DE)

(72) Inventor: Hermann Aicher, Olching (DE)

(21) Appl. No.: 13/876,680

(22) PCT Filed: Sep. 29, 2011
(86) PCT No.: PCT/EP11/67001

§ 371 Date: Apr. 17, 2013

(30) Foreign Application Priority Data
Oct. 2, 2010 (DE) 102010047115.1

(51) Int. Cl. G10L 25/66

(52) U.S. Cl. CPC G10L 25/66
USPC 704/270

(57) ABSTRACT

The invention relates to an exercise and learning concept and to a mobile exercise and learning device for the therapeutic treatment of patients, said concept being based on a network system. Said exercise and learning concept and exercise and learning device are used for the therapeutic treatment of patients in order to allow mobile and interactive learning. Said exercise and learning device comprises exercise and learning modules which are individually adapted to a patient who can also perform therapeutic exercises irrespective of the time and place.

Exercise and learning concept using an exercise and learning device for the therapeutic treatment of patients in the medical domain.

### TECHNICAL FIELD

The present invention relates to an exercise and learning concept for remedying physical and/or mental deficiencies of patients according to the preamble of the independent main claim, it further relates to an exercise and learning device for carrying out this method.

### PRIOR ART

Such methods and apparatus relate generally to the field of medicine, preferably to the field of logopaedics or speech therapy, ergotherapy, psychology, neurology, Parkinson's disease, traumatology, surgery, gerontology and gynaecology as far as into the field of sports injuries. In the field of logopaedics or speech therapy, hitherto work has predominantly been carried out personally between patient and therapist who usually arranges an appointment with the patient once or twice a week and practices the elements to be learnt with the patients, for example, phonemes, syllables, words or sentences. Frequently these are integrated in a self-designed game or he uses prepared cards or board games. Many personal and computer-assisted speech therapy and logopaedic therapy methods are used for this purpose in therapeutic practices. Thus, for example, after returning from the rehabilitation clinic, stroke patients receive a visit about once a week, usually for 30 minutes, from the speech therapist who carries out speech exercises, for example, with the patient in this time. For the rest of the time the patient is frequently left alone as a result of the massive cost pressure in health care. In this case, the patient could make better use of the remaining time for exercises. For this, however the patient lacks the appropriate means in the form of technical equipment. Various exercise and learning devices are known from the prior art, thus for example DE 23 04 070 C2 discloses a speech exercise device with a microphone which primarily serves for speech recognition and is not suitable for modern therapy which also includes writing, movement and logic exercises, i.e. mental exercises. DE 20 2005 001 991 U1 discloses a more extensive exercise and learning device as a portable device. A daily individual training by pronouncing correct syllables or words is possible with this handy hand-held device into which the syllables to be practiced are transferred by the treating speech therapist and stored there, and which is given to the patient for training at home. A disadvantage here is that it is only suitable for training the hearing process and hearing perception as it operates purely auditively and does not permit interactive exercise and learning. In accordance with DE 20 2006 010 715 U1, this hand-held device according to DE 20 2005 001 991 U1 has an LCD display for user guidance without remedying the disadvantages indicated previously.

DE 103 59 360 A1 discloses a method for hemisphere-specific integration and control of speech-therapy or logopaedic contents, whose training method relies on the fact that the patient has his own computer with memory reader. The patient is handed a memory medium with a training program with which he can start the training program in his computer. Another memory medium is required for additional and/or new speech therapy exercises. The monitoring of the training course carried out can also be recorded on a memory medium. A disadvantage is the lack of interactivity so that it is not possible to monitor the exercises carried out by the patient promptly since this monitoring and evaluation of the patient's progress with the speech therapy and logopaedic exercises can only be carried out by the speech therapist after the speech therapist has retrieved the memory medium and evaluated the control files. According to the prior art, information is transferred to the patient's hand-held device without there being the possibility for didactic interactions.

### DESCRIPTION OF THE INVENTION

There is therefore a need for an exercise and learning concept using an exercise and learning device for interactive communication between an input device and a terminal. It is therefore the object of the invention to remedy the disadvantages of known methods and devices for the therapeutic treatment of logopaedics, ergotherapy, psychology and neurology patients and provide a generic exercise and learning method to remedy physical and/or mental deficiencies of patients; it further relates to further developing the exercise and learning device which can be used for this purpose so that interactivity is given and by which means an economical execution is made possible in which the patient is enabled to exercise and to learn at any time and at any place without major loss of time.

The solution of the object is described in the features of the characterizing part of the independent claim, the dependent subclaims describe the further developments and the configuration of the exercise and learning device.

Hardware and software are available for the exercise and learning concept. It has an input device on which the therapist generates at least one exercise and learning module, a communications server on which at least one exercise and learning module is stored, furthermore a terminal which becomes an exercise and learning device by installation of the software, which has access to the communications server and therefore also access to the exercise and learning module intended for this exercise and learning device in the communications server, as well as an internet network, communication network and/or intranet network for transmission of the exercise and learning module, where execution and success of the exercises is recorded in a monitoring protocol on the communications server.

Through its interactivity in therapeutic treatments, this exercise and learning concept makes it possible, along with the exercising, to monitor the execution and success through the monitoring protocols produced in the background in, for example, individual speech treatments, by frequent repetition of certain sounds or combinations of sounds in words or therefore also the frequent pronunciation of certain words, in individual writing exercises by frequent repetition of specific sentences, in individual text exercises by frequent repetition of certain words, in individual movement exercises by frequent repetition of certain finger exercises and in individual logic exercises, e.g. through the appropriate choice of pictures. In such an individual concept and device, media examples of the patient (e.g. image/sound files of family members) can be incorporated in the exercise and learning tasks.

As a result of the numerous possible and supplied exercise and learning modules, the most diverse clinical pictures can be supported in the healing process, e.g. speech disorders or movement disorders. And as a result of the immediate availability of the learning modules on the exercise and learning devices, it is possible to provide the patients with exercise and learning means for the therapy which enable him to carry out the exercises alone. At the same time, the exercise and learning modules are stored on the communications server. From this server the exercise and learning modules are either downloaded onto the exercise and learning device to which this exercise and learning module is assigned or they are available interactively for this exercise and learning device. The example explained in more detail here relates to the specific application of the exercise and learning concept in a clinic without making a restriction to other areas.

In a clinic there are a number of, for example, accident and stroke patients who require treatment in the field of logopaedics, speech therapy, ergotherapy, psychology, neurology and for certain sports injuries. Usually after treatment by a doctor in the clinic, these patients are immediately treated by therapists in various ways to speed up the healing process according to the required subject area by means of personally matched exercises which promote the healing process. On account of the low availability of therapists, doctors and care workers and the cost savings in health care, patients are increasingly suffering from a lack of optimum therapeutic provision. The lack of provision in therapy is remedied by the interactivity of the exercise and learning concept.

To this end, an exercise and learning concept must satisfy various criteria: it must be user-friendly for the patient and efficient for the therapist in order to be able to meet specific requirements in the therapy. The exercise and learning device provides the patient or the person in need of care with a technical aid for therapy, information and communication. In order that this device can fulfil all the requirements, it is incorporated in the exercise and learning concept, in that of the relevant physician, speech therapist or specialist staff trained in special subject areas to individually generate the therapeutic exercises required by the patent in an exercise and learning module on an input device, for example, a computer, a notebook or similar. The computer can comprise a stand-alone single-user computer which is incorporated in a network as a single-user computer. The input device is located, for example, at the clinic, in the clinic office of the doctor or in the treatment area or in an office of a responsible member of the technical staff which on the one hand can be in the clinic and on the other hand can also be outside the clinic. If the exercise and learning module is generated by a psychotherapist, possibly a speech therapist or a physiotherapist, the input device can be located in their practice. In order that that exercise and learning modules generated on the input device can also be provided on the exercise and learning device made available to the patient, an internet network or, for example, in the case of the doctor in the clinic, an intranet is provided. Both networks have access to a specific communications server which is advantageously located in the clinic, but external servers, for example, the internet, can also be used.

Each of the exercise and learning modules generated on the input devices can be compiled for one or more patients, taking into account his or her clinical picture individually with an address structure and his patient data. Thus, one of the exercise and learning modules can be selected by the doctor or therapist from the communications server and assigned to one or more specific target addresses of the exercise and learning devices of the patients so that after switching on an exercise and learning device, the exercise and learning concept is available to him with the one exercise and learning module intended for him or various exercise and learning modules combined for him to which the exercise and learning device of this patient has access. The exercise and learning modules available at the present time consist of a speech module, a writing module, a text module, a picture module, a movement module and a logic module. Each of these modules can be matched individually to the needs of a patient.

Either this exercise and learning module is installed automatically by the communications server on the exercise and learning device or this exercise and learning module is retrieved by downloading from the communications server. Alternatively the exercise and learning device interactively accesses this exercise and learning module which itself remains on the communications server. Access of the exercise and learning devices can be accomplished via an internet network and/or—if the exercise and learning devices are fitted with SIM cards meeting the GSM and UMTS standard—via a mobile radio network. As a result of the server and network technology, a plurality of exercise and learning devices can be connected and supplied with exercise and learning modules so that at the same time a plurality of exercise and learning devices available at the present time can be used locally and temporally independently of one another. The patient therefore has the possibility of being able to perform exercises along at any time of day, e.g. in the hospital bed of the general clinic, in the rehabilitation clinic, in the care home, at home or when travelling.

In order to [fulfil] the previously indicated requirements satisfied according to the invention for the exercise and learning device as part of the exercise and learning concept according to the invention in which the terminals receive their functionality as with the installation of an exercise and learning module, the exercise and learning device requires an efficient processor and various other properties such as, for example, size of memory, type of operating system, optimal visual recording and reproduction, optimal acoustic recording and reproduction and online or network capability. Mobile terminals such as, for example, smartphones and/or PDA (person digital assistant) and/or tablet PCs are used as the basis for the exercise and learning device which have at least the performance of a smart phone, an iPad and/or iPhone and which have a touchscreen in slide technology. Such an exercise and learning device which implements the exercise and learning concept according to the invention is not bound to the location and is therefore available to the patient at any location and at any time for exercising and learning.

The patient can, for example, select categories, e.g. animals, family or technology etc. in the exercise and learning module as part of his speech and writing exercises and then make speech recordings with scope for monitoring. To this end, the exercise and learning device prepares a monitoring protocol in the background during completion of an exercise and learning unit, which serves as dialogue preparation and which can be retrieved by the patient in the information region of the communication device, which contains the recordings of the exercises or the results and which also serves as dialogue preparation and can be called up by the patient in the information region of the communication device and is therefore available to him for self-monitoring. A prepared monitoring protocol can be continuously transmitted interactively by the exercise and learning device to the communications server during exercising. From the communications server the treating doctor or the relevant speech therapist or the relevant specialist staff can load the data of the monitoring protocol onto his input device and evaluate the results of the patient's exercises, where it is understood that doctor, speech therapist or specialist staff only have access to the returning monitoring protocols of the exercise and learning modules which have been generated by their input device and sent to specific addresses of the exercise and learning device, where each address is assigned a specific exercise and learning device which in turn was handed out to a specific patient.

Following the evaluation of a monitoring protocol, a communication, e.g. a final discussion or a discussion on the status of the exercises, can take place between the patient and the therapist. However, it is also possible that another exercise and learning module is generated for the patient, which includes extensions and additions whereby the degree of difficulty of the exercises can be increased. The exercise and learning modules are each adapted individually by the therapist according to the patient's progress with healing and learning. Also an additional exercise and learning module can now be made available to the patient. This or a plurality of exercise and learning modules again arrive via the network system, as described previously. The patient can now perform the other exercises created for him on his exercise and learning device, where, as described previously, a monitoring protocol is again created. As a result of the continuous readiness of an exercise and learning device, the patient can control his learning sequence as required which is any case is higher than it would have been with only a weekly visit of a therapist. The advantage of such an exercise and learning concept according to the invention is that compared with conventional personally executed therapy, it is readily obvious. Personal discussion between a patient and a therapist is retained but the patient now has the exceptional possibility of increasing the exercise units according to his capabilities and needs in order to speed up the healing process and improve learning results more rapidly, thus promoting the independence of the patient. The exercise and learning concept thus brings about a saving of time and costs in the therapy.

It should also be mentioned that an exercise and learning device contains further advantageous devices, for example, an entertainment region and/or a communication region which can be retrieved via the communication device.

Another advantage of the exercise and learning device according to the invention is that before starting an exercise and learning module, the patient can make a selection of language in the system region of the communication device. This choice of language can also be pre-set by the therapist. To this end, the corresponding button on the touch-sensitive display of the exercise and learning device can be touched by the patient or therapist. With the selected language, the patient can receive all the information in his national language. German or English can be pre-set as standard languages in the system region of the communication device. The additional functions of the exercise and learning module are then available in the national language selected in each case. Additional languages such as, for example, French, Italian, Spanish or Turkish are optionally available, whereby the exercise and learning modules are available to the patient in his national language. If the exercise and learning concept is used with the appurtenant exercise and learning devices in other countries, naturally the national language—e.g. Italian—is pre-set as standard in the exercise and learning device and can be optionally selected.

In an advantageous further development of the exercise and learning device, it is provided that the exercise and learning device in the communication device in the information region has a device which enables the patient to communicate with the doctor, the therapist and/or with the patient. In the entertainment region the patient has the possibility to surf the internet and to access films, games and audio files.

The exercise and learning concept according to the invention has been presented for the example of a speech therapist where the emphasis lies on the processing of hearing and perception of hearing although the exercise and learning concept can naturally also be used for other therapists. Thus, for example, in the case of a sports injury to the hands of a patient, an exercise and learning module can be provided in which finger exercises can be carried out. For this purpose, a movement module is available as an exercise and learning module, e.g. an exercise video, in the communication device. This example should illustrate what possibilities are available for use of the exercise and learning device in conjunction with the exercise and learning concept.

### BRIEF DESCRIPTION OF THE DRAWINGS

A specific exemplary embodiment of the invention is shown schematically in the drawings and will be described in detail hereinafter. In the figures:

FIG. 1 shows a schematic view of an interactive exercise and learning concept which comprises a network system, at least one input device, at least one communications server and at least one exercise and learning device, and

FIG. 2 shows an illustrated view of an exercise and learning device according to the invention which comprises a communication device, by which means the exercise and learning modules can be retrieved for training, and by which means a dialogue is prepared.

### BEST MODE FOR IMPLEMENTING THE INVENTION

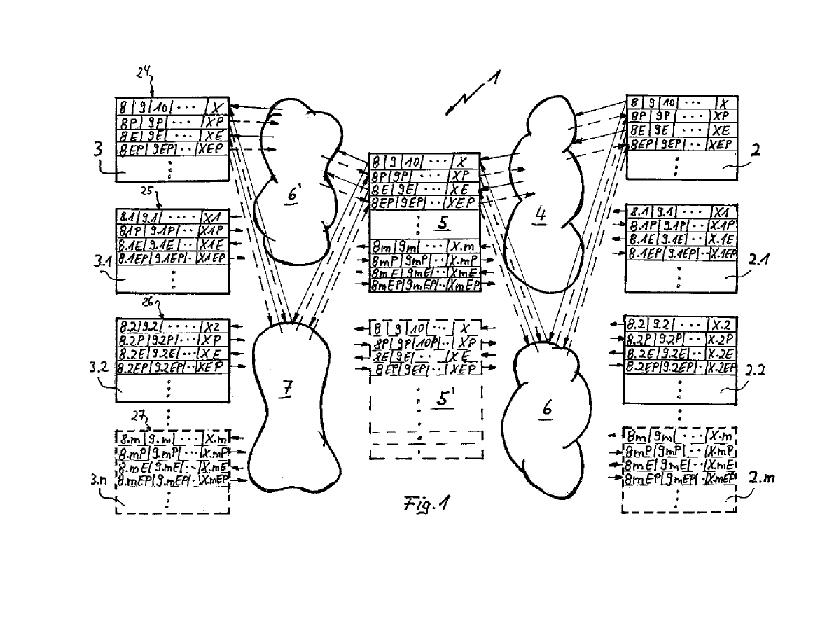

FIG. 1 shows in schematic view a specific exemplary embodiment of an exercise and learning concept according to the invention. The exercise and learning concept comprises a network system 1, in order to be able to provide the exercise and learning modules 8, 9, 10, 11, 12, 13 generated by the input devices 2, 2.1, 2.2 . . . 2.n on the mobile exercise and learning devices 3, 3.1, 3.2, . . . 3.n and be able to receive feedback about and evaluate the exercises carried out and learning goals achieved by reference to created monitoring protocols.

The exercise and learning concept comprises a network system 1 for transmitting digital information between at least one digital input device 2 and at least one portable exercise and learning device 3 fitted with a touch-sensitive display 17, where the digital information is transmitted via at least one intranet network 4, via at least one communications server 5, via at least one internet network 6 and/or via a local wireless communication network 7 (WLAN, LAN, DSL, . . . ). The exercise and learning concept is executed by means of software which is stored on hardware, possibly on an input device 2 on which at least one exercise and learning module 8 is generated, a communications server 5 on which at least one exercise and learning module 8 is stored and an exercise and learning device 3 which in the present task has access to the exercise and learning module 8 intended for its patients “A” 24, “B” 25, “C” 26 . . . “Y” 27. This exercise and learning module 8 is either automatically downloaded from the communications server 5 and preferably automatically stored on the exercise and learning device 3 or its exercise and learning device 3 is continuously interactively connected to the communications server 5 for executing the exercise and learning module 8. The transmission of the exercise and learning modules 8, 9, 10, 11, 12, 13 and the monitoring protocols 8P, 9P, 10P, 11P, 12P, 13P between the communications server 5 and the exercise and learning devices 2 is accomplished by means of an internet network 6 and/or an intranet network 4. In both cases, the exercise and learning module 8 intended for the patient or patients “A” 24, “B” 25, “C” 26 . . . “Y” 27 is available for retrieval and execution of the exercises on his exercise and learning device 3.

The input device 2 can be at a doctor's in the clinic, at a speech therapist in the practice or with specialist staff in the office, where the locations of the input devices can be spatially very remote from one another. The number of input devices 2 is not limited here. The exercise and learning modules 8, 9, 10, 11, 12, 13 to X are created on the input devices by the therapist. For example, the exercise and learning modules 8, 9, 10, 11, 12, 13 to X are generated on the input device 2 of the doctor, the exercise and learning modules 8.1, 9.1, 10.1, 11.1, 12.1, 13.1 to X.1 on the input device 2.1 of the speech therapist, the exercise and learning modules 8.2, 9.2, 10.2, 11.2, 12.2, 13.2 to X.2 on the input device 2.2 of the specialist staff as far as the exercise and learning modules 8.m, 9.m, 10.m, 11.m, 12.m, 13.n to X.m on the input device 2.m or available exercise and learning modules are selected. Each of these generated exercise and learning modules 8, 9, 10, 11, 12, 13 is adapted individually to the requirement of one or more patients “A” 24, “B” 25, “C” 26 . . . “Y” 27 and is sent via a network 4, 6 to a communications server 5, 5′, where a plurality of communications servers 5, 5′ can be available for use of the exercise and learning concept. Each exercise and learning module 8, 9, 10, 11, 12, 13 to X is provided on a communications server 5, 5′. That is, the communications server 5, 5′ has stored a plurality of exercise and learning modules 8, 9, 10, 11, 12, 13 to X and holds them in readiness for automatic update to the exercise and learning devices 3, 3.1, 3.2, . . . 3.n or for automatic retrieval by the exercise and learning devices 3, 3.1, 3.2 . That is, there are two methods of equipping the exercise and learning devices 3, 3.1, 3.2, . . . 3.n with the exercise and learning modules 8, 9, 10, 11, 12, 13 to X generated by the therapist. On the one hand, the communications server 5, 5′ can simultaneously or in time-displaced manner automatically provide the individually different exercise and learning modules 8, 9, 10, 11, 12, 13 to X to the exercise and learning devices 8, 9, 10, 11, 12, 13 to X and thereby make an upgrading or update and on the other hand, the exercise and learning devices 3, 3.1, 3.2, . . . 3.n can download the individual exercise and learning modules 8, 9, 10, 11, 12, 13 to X from the communications server 5, 5′. Alternatively, the exercise and learning devices 3, 3.1, 3.2, . . . 3.n have interactive access to the exercise and learning modules 8, 9, 10, 11, 12, 13 to X on the communications server 5, 5′.

As an example and representative for all input devices 2, 2.1, 2.2 to 2.m, a specific sequence is shown for the example of the input device 2. An exercise and learning module 8 for speech exercises, generated by the therapist on the input device 2, which was created individually for a specific patient “A” 24, is provided with a specific address on the basis of the existing address structure in the exercise and learning devices 3, 3.1, 3.2, . . . 3.n. In the present example, this relates to the exercise and learning device 3. This exercise and learning device 3 was handed over to the patient “A” 24 for training of the speech exercises contained in the exercise and learning module 8. The exercise and learning module 8 generated for the patient “A” 24 is sent via a network 4 or 6 to the communications server 5. The communications server 5 stores the exercise and learning module 8 in a list. If the communications server 5 determines that the exercise and learning device 3 of the patient “A” 24 is switched on and is therefore operating or online, the communications server 5 performs an update on the exercise and learning device 3 or allows the exercise and learning device 3 to access this exercise and learning module 8 for downloading or for interactive communication so that the exercise and learning device 3 has available the exercise and learning module 8 generated individually for this patient “A” 24 by the therapist for carrying out the exercises. An internet network 6′ or a WLAN/LAN/DSL network 7 is available to the communications server 5 as a path for the exercise and learning module 8 or for communication with the exercise and learning device 3 according to which network 6′, 7 is available. As already mentioned previously, however, there is also the possibility that the exercise and learning device 3 can download the exercise and learning module 8 from the communications server 5 via the network 6′ or 7 or can interactively access the exercise and learning module 8 assigned to this exercise and learning device 3.

In the same way, a therapist can create further individual exercise and learning modules 8, 9, 10, 11, 12, 13 to X for the patients “B” 25, “C” 26 . . . “Y” 27 on his input device 2 or select from available exercise and learning modules and send via the previously indicated path to the exercise and learning devices 3.1, 3.2, to 3.n. A therapist therefore has available to him with the exercise and learning concept according to the invention and the appurtenant exercise and learning devices according to the invention, a technical system which enables him to provide a plurality of patients “A” 24, “B” 25, “C” 26 . . . “Y” 27 with a therapeutic device.

According to a further aspect of the invention, for example, the input device 2 of the doctor can transmit exercise and learning modules 8, 9, 10, 11, 12, 13 to the exercise and learning device 3.1 of the patient “B” 25, the input device 2.1 of the speech therapist can transmits these modules to the exercise and learning device 3.2 of the patient “C” 26 and the input device 2.2 of the specialist staff can transmit these modules to the exercise and learning device 3 of the patient “A” 24 etc.

Advantageously the exercise and learning concept is adjustable in such a manner that individual exercise and learning modules 8.1, 9.1, 10.1, 11.1, 12.1, 13.1 to X.1 can be generated not only on the input device 2 but also on the further input devices 2.1, 2.2 to 2.m. e.g. on the input device 2.1 of the speech therapist, or exercise and learning modules 8.2, 9.2, 10.2, 11.2, 12.2, 13.2 to X.2 can be generated, for example, on the input device 2.2 of the specialist staff and can be transmitted via the previously indicated path to the exercise and learning devices 3, 3.1, 3.2, . . . 3.n. It is a requirement that these input devices 2.1, 2.2 to 2.m are part of the exercise and learning concept and have access to the communications server 5, 5′. It is therefore possible even for external speech therapists to provide therapy to clinic patients on the one hand and patients in their own home on the other hand.

The patient “A” 24, “B” 25, “C” 26 . . . “Y” 27 therefore receives from the therapist, a doctor or speech therapist or specialist staff an exercise and learning device 3, 3.1, 3.2, . . . 3.n specially set up for his clinical picture comprising one or more selected exercise and learning modules 8, 9, 10, 11, 12, 13 to X matched to the patient “A” 24, “B” 25, “C” 26 . . . “Y” 27. After switching on the exercise and learning device 3, 3.1, 3.2, to 3.n or after starting the operating system, a communication device 15 is started. This communication device 15 displays in a pre-set language various regions for operation. The regions relates to an exercise and learning region 18, a system region 19, an information region 20, an entertainment region 21, an emergency region and a program assistance region 23. The communication device 15 holds these regions ready for selection for the patient “A” 24, “B” 25, “C” 26 . . . “Y” 27 in the first operating step. The patient “A” 24, “B” 25, “C” 26 . . . “Y” 27 makes the selection of a region by operating the touch-sensitive display 17. After, for example, the selection of the exercise and learning region 18, the selection of an exercise and learning module 8, 9, 10, 11, 12, 13 to X takes place in the second operating step. The exercise and learning modules 8, 9, 10, 11, 12, 13 to X consist of individual modules, the speech module 8, the writing module 9, the text module 10, the picture module 11, the movement module 12 and the logic module 13. In the third operating step, a selected exercise and learning module 8, 9, 10, 11, 12, 13 to X is used. Usage consists in, after selecting an exercise and learning module 8, 9, 10, 11, 12, 13 to X, beginning the exercise and learning phase by means of pre-settings. Exercise and learning modules can also be selected and started without connection to the communications server, i.e. offline, on the exercise and learning devices.

During the exercise and learning phases, a monitoring protocol 8P, 9P, 10P, 11P, 12P, 13P to XP is created by the exercise and learning device. After the end of the exercise and learning phase or after closure of the exercise and learning module 8, 9, 10, 11, 12, 13 to X, the monitoring protocol 8P, 9P, 10P, 11P, 12P, 13P to XP is stored on the one hand for dialogue preparation 30 in the information region 20 and on the other hand sent automatically to the communications server 5, 5′ or retrieved directly or in a temporally offset manner from the communications server 5, 5′. The monitoring protocol 8P, 9P, 10P, 11P, 12P, 13P to XP stored on the communications server 5, 5′ can be retrieved by the input device 2, 2.1, 2.2 to 2.m. In order to come back to the initial example of the use of the input device 2, this means that when the exercise and learning module 8 is used by the patient “A” 24, a monitoring protocol 8P is created on the exercise and learning device 3. The monitoring protocol 8P is stored on the one hand for dialogue preparation 30 for the patient “A” 24 in the information region 20 and on the other hand the monitoring protocol 8P is transmitted via the available network system 6, 7 to the communications server 5, 5′. The monitoring protocol 8P can, however, also be requested by the communications server 5, 5′. The monitoring protocol 8P stored on the communications server 5, 5′ can be retrieved by the input device 2. The monitoring protocol 8P is then evaluated on the input device 2 by the relevant therapist.

In this way, a therapist can download and evaluate the further monitoring protocols 9P, 10P, 11P, 12P, 13P to XP from the communications server 5, 5′ on his input device 2. This also relates to the monitoring protocols of the individual exercise and learning modules 8, 9, 10, 11, 12, 13 to X of the patients “B” 25, “C” 26 . . . “Y” 27 which return to the input device 2 via the previously indicated path. With the exercise and learning concept according to the invention and the appurtenant exercise and learning devices according to the invention, a therapist therefore has a technical system available which enables him not only to provide a plurality of patients with a therapy device but also to monitor the learning progress of the patients.

Advantageously the exercise and learning concept is adjustable in such a manner that the monitoring protocols 8.1P, 9.1P, 10.1P, 11.1P, 12.1P, 13.1P to X.1P created from the exercise and learning modules 8.1, 9.1, 10.1, 11.1, 12.1, 13.1 to X.1 used can be evaluated not only on the input device 2 but also on the further input devices 2.1, 2.2 to 2.m, e.g. on the input device 2.1 of the speech therapist. Also the monitoring protocols 8.2P, 9.2P, 10.2P, 11.2P, 12.2P, 13.2P to X.2P returning to the input device 2.2 from the exercise and learning device 3.2, generated on the basis of the exercise and learning modules 8.2, 9.2, 10.2, 11.2, 12.2, 13.2 to X.2 originally sent by the input device 2.2 can be evaluated by this device. External speech therapists and/or specialist staff therefore not only have the possibility of providing therapy to clinic patients on the one hand and patients in their own home environment on the other hand but can also monitor the learning progress of the patients.

If the evaluation of the monitoring protocol 8P, 9P, 10P, 11P, 12P, 13P to XP gives satisfactory results, the exercise and learning concept can be concluded with a conversation or communication between the therapist and the patient “A” 24, “B” 25, “C” 26 . . . “Y” 27. If the evaluation is not yet satisfactory and the state of the illness requires further therapeutic measures, the therapist can provide further exercise and learning modules to the patent “A” 24, “B” 25, “C” 26 . . . “Y” 27 for training until the healing and learning process of the patient “A” 24, “B” 25, “C” 26 . . . “Y” 27 is satisfactory. With the exercise and learning concept described, the therapist has the possibility for providing the patient “A” 24, “B” 25, “C” 26 . . . “Y” 27 with as many exercise and learning modules 8, 9, 10, 11, 12, 13 to X until the healing process has progressed so far that the therapeutic treatment can be concluded and the healing and learning progress of the patient “A” 24, “B” 25, “C” 26 . . . “Y” 27 is satisfactory. With the exercise and learning concept described, the therapist has the possibility of providing the patient “A” 24, “B” 25, “C” 26 . . . “Y” 27 with so many exercise and learning modules 8, 9, 10, 11, 12, 13 to X until the healing process is so far advanced that the therapeutic treatment can be concluded.

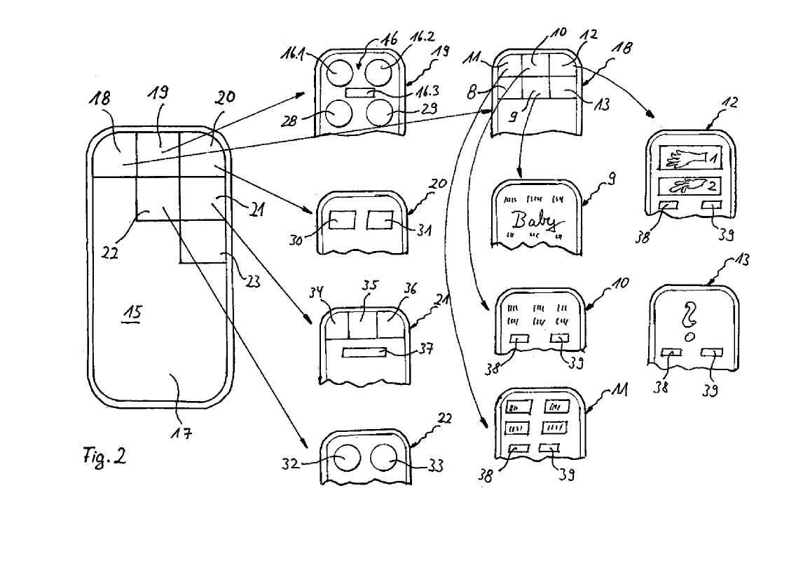

These new exercise and learning modules 8E, 9E, 10E, 11E, 12E, 13E to XE are again individually adapted by the therapist according to the healing and learning process of the patient “A” 24, “B” 25, “C” 26 . . . “Y” 27. An additional exercise and learning module can also now be made available to the patient “A” 24, “B” 25, “C” 26 . . . “Y” 27. This extended exercise and learning module 8E or plurality of exercise and learning modules 9E, 10E, 11E, 12E, 13E to XE with the individual learning elements again reach the patient “A” 24, “B” 25, “C” 26 . . . “Y” 27 by the same path, i.e. from the input device 2, 2.1, 2.2 to 2.m via the network system and the communications server 5, 5′ to the exercise and learning device 3, 3.1, 3.2, to 3.n. The patient “A” 24, “B” 25, “C” 26 . . . “Y” 27 can now perform further exercises compiled for him on his exercise and learning devices 3, 3.1, 3.2, to 3.n, where, as described previously, a monitoring protocol 8EP, 9EP, 10EP, 11EP, 12EP, 13EP to XEP is again compiled. These monitoring protocols 8EP, 9EP, 10EP, 11EP, 12EP, 13EP to XEP again return to the input device 2, 2.1, 2.2 to 2.m on the known path. Further details on the exercise and learning devices 3, 3.1, 3.2, to 3.n are contained in FIG. 2. Corresponding reference numbers are provided with the same reference numbers in FIG. 2.

If the evaluation of the monitoring protocols 8EP, 9EP, 10EP, 11EP, 12EP, 13EP to XEP gives satisfactory results, the exercise and learning concept is completed with a discussion between the therapist and the patient “A” 24, “B” 25, “C” 26 . . . “Y” 27. If the evaluation is still not satisfactory and the state of the illness requires further therapeutic measures, the therapist can provide the patient “A” 24, “B” 25, “C” 26 . . . “Y” 27 with further exercise and learning modules for training until the healing and learning progress of the patient “A” 24, “B” 25, “C” 26 . . . “Y” 27 is satisfactory. That is, with the exercise and learning concept the therapist has the possibility of providing the patient “A” 24, “B” 25, “C” 26 . . . “Y” 27 with as many exercise and learning modules 8, 9, 10, 11, 12, 13 to X until the healing process is so far advanced that the therapeutic treatment can be concluded.

An exercise and learning device 3, 3.1, 3.2, to 3.n according to the invention for carrying out the method according to claim 1 can be seen from FIG. 2 in illustrated view. Descriptions and details which are contained identically in FIG. 1 are identified with the same reference numbers.

The exemplary embodiment according to FIG. 2 substantially comprises at least one portable exercise and learning device 3 which is equipped for operation with a touch-sensitive display 17, where the exercise and learning device 3 has hardware and software which provide means for exercise and learning. Since the exercise and learning devices 3, 3.1, 3.2, to 3.n are all fitted identically or the same with regard to the base functions, hereinafter only the exercise and learning device 3 is described as representative for the exercise and learning devices 3, 3.1, 3.2, . . . 3.n.

The exercise and learning device 3 is fitted with a communication device 15 which is available on the display 17 after starting the operating system. On the opening page, the communication device 15 has various regions 18, 19, 20, 21, 22, 23 to be operated. That is, the communication device 15 is fitted with an exercise and learning region 18, a system region 19, an information region 20, an entertainment region 21, an emergency region 22 and a program assistance region 23 and administers these. In the first operating step, for example, the exercise and learning region 18 can be retrieved. The exercise and learning region 18 is fitted with exercise and learning modules 8, 9, 10, 11, 12, 13 to X. In online operation, as indicated in the description of FIG. 1, the exercise and learning modules 8, 9, 10, 11, 12, 13 to X are either loaded by the communications server 5, 5′ onto the exercise and learning device 3 or the exercise and learning device 3 downloads these from the communications server 5, 5′. Alternatively, the exercise and learning device directly interactively accesses the exercise and learning module on the communications server. The exercise and learning modules 8, 9, 10, 11, 12, 13 to X consist of a speech module 8, a writing module 9, a text module 10, a picture module 11, a movement module 12 and a logic module 13. Insofar as all the exercise and learning modules 8, 9, 10, 11, 12, 13 to X are available on the exercise and learning device 3, the patient “A” 24, “B” 25, “C” 26 . . . “Y” 27 can make a selection between these. Naturally in simple cases, the patient does not need to have all the possible, exercise and learning modules 8, 9, 10, 11, 12, 13 to X available. It can be completely sufficient to provide only one exercise and learning module, e.g. the movement module 12, to the patient “A” 24, “B” 25, “C” 26 . . . “Y” 27 on his exercise and learning device, i.e. the exercise and learning device 3. The patient “A” 24, “B” 25, “C” 26 . . . “Y” 27 can simply call up this exercise and learning module 12 without needing to make a choice. If, for example, the speech module 8 was called up, the patient “A” 24, “B” 25, “C” 26 . . . “Y” 27 can begin immediately with the exercises. The exercise and learning device 3 is fitted with means for recording a monitoring protocol 8P, 9P, 10P, 11P, 12P, 13P to XP. During the exercise phase, the exercise and learning device 3 automatically applies a monitoring protocol 8P, 9P, 10P, 11P, 12P, 13P to XP whilst the patient “A” 24, “B” 25, “C” 26 . . . “Y” 27 performs his exercises. The monitoring protocol 8P, 9P, 10P, 11P, 12P, 13P to XP can be called up by the patient “A” 24, “B” 25, “C” 26 . . . “Y” 27 after performing the exercises or after closing the exercise and learning modules 8, 9, 10, 11, 12, 13 via the system region 19 under the dialogue preparation 30 for self-monitoring. Furthermore, the exercise and learning device 3 is fitted with means for transmitting the recorded monitoring protocol 8P, 9P, 10P, 11P, 12P, 13P to XP. The monitoring protocols 8P, 9P, 10P, 11P, 12P, 13P to XP are automatically sent via a network 6′, 7 to the communications server 5, 5′. The exercise and learning modules 8, 9, 10, 11, 12, 13 have forwards 39 and backwards 38 buttons on the display of the communication device 15.

The communication device 15 of the exercise and learning device 3 in the system region 19 is fitted with a language selection 16, an update service and a backup system. The language of the communication device 15 is set as standard in “German” or “English” on the exercise and learning device. A change to the pre-set language can be made in the system region 19 under language selection 16. The language selection 16 has three different buttons I, II, III 16.1, 16.2, 16.3. The button I 16.1 corresponds to the national language “German”, the button II 16.2 corresponds to the national language “English” and the button III 16.3 opens another page for the selection of different languages. With actuation of one of the buttons I, II, III 16.1, 16.2, 16.3, the patient “A” 24, “B” 25, “C” 26 . . . “Y” 27 selects the language of the communication device 15. After actuating the language selection, e.g. “German” or the button I 16.1 on the touch-sensitive display 17 with an input stylus or with the finger, the national language “German” is set as standard. Upon actuation of the button III 16.3 “other languages”, another window appears with selection of the languages, e.g. “Turkish”, “Italian” and “French”. These languages are optional and must be registered before use. After the language selection 16, the patient “A” 24, “B” 25, “C” 26 . . . “Y” 27 has the possibility, through the communication device 15, to be able to select and call up the exercise and learning region 18, the system region 19, the information region 20, the entertainment region 21, the emergency region 22 or the program assistance region 23 in his language.

The information region 20 of the exercise and learning device comprises an individual dialogue preparation 30, a communication connection to other exercise and learning devices 3, 3.1, 3.2, to 3.n, e.g. to other patients or therapists and to the communications server 5. Access to a care service, possibly “meals on wheels” or the like is also provided. The entertainment region 21 enables access, for example, to films, music, games and the internet whilst the emergency region 22 is equipped with emergency information and emergency functions.

The exercise and learning concept for application of an exercise and learning device 3, 3.1, 3.2, . . . 3.n in offline mode comprises at least one portable exercise and learning devices 3, 3.1, 3.2, . . . 3.n which has hardware and software which provide means for exercising and learning and is equipped with a touch-sensitive display 17 for operation. Such an exercise and learning concept in offline mode is characterised by an input device 2, 2.1, 2.2, . . . 2.m which can generate at least one exercise and learning module 8, 9, 10, 11, 12, 13 and an exercise and learning device 3, 3.1, 3.2, . . . 3.n which is fitted with a communication device 15. The communication device 15 is fitted with an exercise and learning region 18, a system region 19, an information region 20, an entertainment region 21, an emergency region 22 and a program assistance region 22 and has a function with which a connection can be made to the input device 2, 2.1, 2.2, . . . 2.m. Via this connection the exercise and learning modules 8, 9, 10, 11, 12, 13 are transmitted from an input device 2, 2.1, 2.2, . . . 2.m to an exercise and learning device 3, 3.1, 3.2, . . . 3.n and also the monitoring protocols 8P, 9P, 10P, 11P, 12P, 13P are transmitted back from the exercise and learning device 3, 3.1, 3.2, . . . 3.n to an input device 2, 2.1, 2.2, . . . 2.m. The exercise and learning region 18 is fitted with exercise and learning modules 8, 9, 10, 11, 12, 13. These exercise and learning modules 8, 9, 10, 11, 12, 13 consisting of a speech module 8, a writing module 9, a text module 10, a picture module 11, a movement module 12 and a logic module 13 can be called up directly by the terminal 3, 3.1, 3.2, . . . 3.n. Furthermore, the exercise and learning device 3, 3.1, 3.2, . . . 3.n has means for recording a monitoring protocol 8P, 9P, 10P, 11P, 12P, 13P to XP.

### REFERENCE LIST

TABLE 2

| | |
|---|---|
| 1 | Network system |
| 2 | Input device |
| 2.1 | Input device |
| 2.2 | Input device |
| 2.m | Input device |
| 3 | Exercise and |
| | learning device |
| 3.1 | Exercise and |
| | learning device |
| 3.2 | Exercise and |
| | learning device |
| 3.n | Exercise and |
| | learning device |
| 4 | Intranet network |
| 5, 5′ | Communications |
| | server |
| 6, 6′ | Internet network |
| 6.1 | Internet network |
| 7 | Communication |
| | network (LAN..) |
| 8 | Exercise and |
| | learning module |
| | (speech) |
| 8.P | Monitoring protocol |
| | ELM (speech) |
| 8.E | Extended ELM |
| | (speech) |
| 8.EP | Monitoring protocol |
| | ELM (speech) |
| 8.1 | Exercise and |
| | learning module |
| | (speech) |
| 8.1P | Exercise and |
| | learning module |
| | (speech) |
| 8.1E | Extended ELM |
| | (speech) |
| 8.1EP | Monitoring protocol |
| | ELM (speech) |
| 8.2 | Exercise and |
| | learning module |
| | (speech) |
| 8.2P | Monitoring protocol |
| | ELM (speech) |
| 8.2E | Extended ELM |
| | (speech) |
| 8.2EP | Monitoring protocol |
| | ELM (speech) |
| 8.m | Exercise and |
| | learning module |
| | (speech) |
| 8.mP | Monitoring protocol |
| | ELM (speech) |
| 8.mE | Extended ELM |
| | (speech) |
| 8.mEP | Monitoring protocol |
| | ELM (speech) |
| 9 | Exercise and |
| | learning module |
| | (Sc) |
| 9.P | Monitoring protocol |
| | ELM (Sc) |
| 9.E | Extended ELM (Sc) |
| 9.EP | Monitoring protocol |
| | (Sc) |
| 9.1 | Exercise and |
| | learning module |
| | (Sc) |
| 9.1P | Monitoring protocol |
| | ELM (Sc) |
| 9.1E | Extended ELM (Sc) |
| 9.1EP | Monitoring protocol |
| | (Sc) |
| 9.2 | Exercise and |
| | learning module |
| | (Sc) |
| 9.2P | Monitoring protocol |
| | ELM (Sc) |
| 9.2E | Extended ELM (Sc) |
| 9.2EP | Monitoring protocol |
| | (Sc) |
| 9.m | Exercise and |
| | learning module |
| | (Sc) |
| 9.mP | Monitoring |
| | protocol ELM (Sc) |
| 9.mE | Extended ELM (Sc) |
| 9.meP | Monitoring |
| | protocol (Sc) |
| 10 | Exercise and |
| | learning module |
| | (Tx) |
| 10.P | Monitoring |
| | protocol ELM (Tx) |
| 10.E | Extended ELM (Tx) |
| 10.EP | Monitoring |
| | protocol (Tx) |
| 10.1 | Exercise and |
| | learning module |
| | (Tx) |
| 10.1P | Monitoring |
| | protocol ELM (Tx) |
| 10.1E | Extended ELM (Tx) |
| 10.1EP | Monitoring |
| | protocol (Tx) |
| 10.2 | Exercise and |
| | learning module |
| | (Tx) |
| 10.2P | Monitoring |
| | protocol ELM (Tx) |
| 10.2E | Extended ELM (Tx) |
| 10.2EP | Monitoring |
| | protocol (Tx) |
| 10.m | Exercise and |
| | learning module |
| | (Tx) |
| 10.mP | Monitoring |
| | protocol (Tx) |
| 10.mE | Extended ELM (Tx) |
| 10.mEP | Monitoring |
| | protocol ELM (Tx) |
| 11 | Exercise and |
| | learning module |
| | (picture) |
| 11P | Monitoring |
| | protocol ELM |
| | (picture) |
| 11E | Extended ELM |
| | (picture) |
| 11EP | Monitoring |
| | protocol ELM |
| | (picture) |
| 11.1 | Exercise and |
| | learning module |
| | (picture) |
| 11.1P | Monitoring |
| | protocol ELM |
| | (picture) |
| 11.1E | Extended ELM |
| | (picture) |
| 11.1EP | Monitoring |
| | protocol ELM |
| | (picture) |
| 11.2 | Exercise and |
| | learning module |
| | (picture) |
| 11.2P | Monitoring |
| | protocol ELM |
| | (picture) |
| 11.2E | Extended ELM |
| | (picture) |
| 11.2EP | Monitoring |
| | protocol ELM |
| | (picture) |
| 11.m | Exercise and |
| | learning module |
| | (picture) |
| 11mP | Monitoring |
| | protocol ELM |
| | (picture) |
| 11mE | Extended ELM |
| | (picture) |
| 11mEP | Monitoring |
| | protocol ELM |
| | (picture) |
| 12 | Exercise and |
| | learning module |
| | (movement) |
| 12P | Monitoring |
| | protocol ELM |
| | (movement) |
| 12E | Extended ELM |
| | (movement) |
| 12EP | Monitoring |
| | protocol ELM |
| | (movement) |
| 12.1 | Exercise and |
| | learning module |
| | (movement) |
| 12.1P | Monitoring |
| | protocol ELM |
| | (movement) |
| 12.1E | Extended ELM |
| | (movement) |
| 12.1PE | Monitoring |
| | protocol ELM |
| | (movement) |
| 12.2 | Exercise and |
| | learning module |
| | (movement) |
| 12.2P | Monitoring protocol |
| | (movement) |
| 12.2E | Extended ELM |
| | (movement) |
| 12.2EP | Monitoring protocol |
| | ELM (movement) |
| 12.m | Exercise and |
| | learning module |
| | (movement) |
| 12.mP | Monitoring protocol |
| | (movement) |
| 12.mE | Extended ELM |
| | (movement) |
| 12.mEP | Monitoring protocol |
| | ELM (B) |
| 13 | Exercise and |
| | learning module |
| | (Lo) |
| 13.P | Monitoring protocol |
| | (Lo) |
| 13.E | Extended ELM (Lo) |
| 13.EP | Monitoring protocol |
| | (Lo) |
| 13.1 | Exercise and |
| | learning module |
| | (Lo) |
| 13.1P | Monitoring protocol |
| | ELM (Lo) |
| 13.1E | Extended ELM (Lo) |
| 13.1EP | Monitoring protocol |
| | (Lo) |
| 13.2 | Exercise and |
| | learning module |
| | (Lo) |
| 13.2P | Monitoring protocol |
| | ELM (Lo) |
| 13.2E | Extended ELM (Lo) |
| 13.2EP | Monitoring protocol |
| | ELM (L) |
| 13.n | Exercise and |
| | learning module |
| | (Lo) |
| 13.nP | Monitoring protocol |
| | ELM (Lo) |
| 13.nE | Extended ELM (Lo) |
| 13.nEP | Monitoring protocol |
| | ELM (L) |
| 15 | Communication |
| | device |
| 16 | Language selection |
| 16.1 | “German” button |
| 16.2 | “English” button |
| 16.3 | “Other languages” |
| | button |
| 17 | Display |
| 18 | Exercise and |
| | learning region |
| 19 | System region |
| 20 | Information region |
| 21 | Entertainment |
| | region |
| 22 | Emergency region |
| 23 | Program assistance |
| | region |
| 24 | Patient “A” |
| 25 | Patient “B” |
| 26 | Patient “C” |
| 27 | Patient “Y” |
| 28 | Update |
| 29 | Backup |
| 30 | Dialogue |
| | preparation |
| 31 | Communication (to . . . ) |
| 33 | Emergency numbers |
| 34 | Films |
| 35 | Music |
| 36 | Games |
| 37 | Internet |
| 38 | Forward button |
| 39 | Back button |

1. Exercise and learning concept comprising a network system (1) for the transmission of digital information between at least one digital input device (2) and at least one portable terminal, which is fitted with a touch-sensitive display (17), wherein the digital information is transmitted via at least one intranet network (4), via at least one communications server (5, 5′), via at least one internet network (6) and/or via a local wireless communication network (7), wherein the exercise and learning concept is executed by means of hardware and software, comprising:
a) an input device (2, 2.1, 2.2, . . . 2.m) on which at least one exercise and learning module (8, 9, 10, 11, 12, 13) is generated, which is assigned to the terminal of more or more patients “A” 24, “B” 25, “C” 26 . . . “Y” 27,
b) a communications server (5, 5′) on which at least one exercise and learning module (8) is stored, wherein the exercise and learning module (8, 9, 10, 11, 12, 13) in the present task is available for an exercise and learning device (3, 3.1, 3.2 . . . 3.n),
c) that the terminal is configured as an exercise and learning device (3, 3.1, 3.2, . . . 3.n), which has access to the exercise and learning module (8, 9, 10, 11, 12, 13) intended for the patient (“A” 24, “B” 25, “C” 26 . . . “Y” 27) in the communications server 5 and this can be retrieved for the patient (“A” 24, “B” 25, “C” 26 . . . “Y” 27) and can be applied for therapeutic treatment,
d) an internet network (6, 6′), a communication network (7) and/or an intranet network (4) for interactive transmission of the exercise and learning module (8, 9, 10, 11, 12, 13) and the monitoring protocol (8P, 9P, 10P, 11P, 12P, 13P).

2. The exercise and learning concept according to claim 1, characterized in that each generated exercise and learning module (8, 9, 10, 11, 12, 13) is matched individually to one or more patients “A” 24, “B” 25, “C” 26 . . . “Y” 27 and is provided on the communications server (5, 5′) for access by the exercise and learning device (3, 3.1, 3.2, . . . 3.n).

3. The exercise and learning concept according to claim 2, characterized in that the exercise and learning module (8, 9, 10, 11, 12, 13) can be downloaded automatically to the exercise and learning device (3, 3.1, 3.2, . . . 3.n).

4. The exercise and learning concept according to claim 2, characterized in that the exercise and learning module (8, 9, 10, 11, 12, 13) can be accessed on the communications server (5, 5′) remaining interactive for the associated one of the exercise and learning device (3, 3.1, 3.2, . . . 3.n).

5. The exercise and learning concept according to any one of the preceding claims 1 to 4, characterized in that the communications server (5, 5′) keeps a plurality of exercise and learning modules (8, 9, 10, 11, 12, 13) stored and makes them available simultaneously or in a time-offset manner to different exercise and learning devices (3, 3.1, 3.2, . . . 3.n), wherein the different exercise and learning devices (3, 3.1, 3.2, . . . 3.n) can be fitted with individually different exercise and learning modules (8, 9, 10, 11, 12, 13).

6. The exercise and learning concept according to any one of the preceding claims 1 to 5, characterized in that after switching the exercise and learning device (3, 3.1, 3.2, . . . 3.n) to pre-set language, a communication device (15) is displayed which comprises an exercise and learning region (18), a system region (19), an information region (20), an entertainment region (21), an emergency region (22) and a program assistance region (23) for selection (16) in a first operating step by operation the touch-sensitive display (17) of one of the regions (18, 19, 20, 21, 22, 23) by the patient “A”-“Y” (24, 25, 26, 27).

7. The exercise and learning concept according to any one of the preceding claims 1 to 6, characterized in that in the second operating step after selection of the exercise and learning region (18), a selection of exercise and learning modules (8, 9, 10, 11, 12, 13) is available, which comprise a speech module (8), a writing module (9), a text module (10), a picture module (11), a movement module (12) and a logic module (13).

8. The exercise and learning concept according to any one of the preceding claims 1 to 7, characterized in that after selection of an exercise and learning module (8, 9, 10, 11, 12, 13) the exercise and learning phase begins by reference to the pre-settings and during the exercise and learning phase a monitoring protocol (8P, 9P, 10P, 11P, 12P, 13P) is created which is either transmitted automatically to the communications server (5) after closure of the exercise and learning module (8, 9, 10, 11, 12, 13) or during the exercise and learning phase is uploaded interactively to the communications server according to its progress and can be retrieved by the input device (2, 2.1, 2.2, . . . 2.m) and is stored for dialogue preparation (39) in the information region (20).

9. The exercise and learning concept according to any one of the preceding claims 1 to 8, characterized in that the monitoring protocol (8P, 9P, 10P, 11P, 12P, 13P) is evaluated at the input device (2, 2.1, 2.2, . . . 2.m) and according to the result of the evaluation, the exercise and learning module is provided adapted or extended to the exercise and learning device (3, 3.1, 3.2, . . . 3.n) via the communications server (5, 5′).

10. Exercise and learning device (3) for carrying out the exercise and learning concept according to claim 1, comprises at least one portable exercise and learning device (3, 3.1, 3.2, . . . 3.n), the exercise and learning device (3) has hardware and software which provide means for exercise and learning and which is fitted with a touch-sensitive display (17) for operation, characterized in that
a) the exercise and learning device (3) is fitted with a communication device (15) for interactive communication,
b) the communication device (15) comprises an exercise and learning region (18), a system region (19), an information region (20), an entertainment region (21), an emergency region (22) and a program assistance region (23),
c) the exercise and learning region (18) is fitted with exercise and learning modules (8, 9, 10, 11, 12, 13) which comprise a speech module (8), a writing module (9), a text module (10), a picture module (11), a movement module (12) and a logic module (13),
d) the exercise and learning device (3, 3.1, 3.2, . . . 3.n) [is fitted] with means for creating a monitoring protocol (8P, 9P, 10P, 11P, 12P, 13P) as well as means for transmitting the monitoring protocol (8P, 9P, 10P, 11P, 12P, 13P).

11. The exercise and learning device (3) according to claim 10, characterised in that
a) the system region (19) is fitted with a speech selection (16), with an update service (28) and a backup system (29),
b) the information region (20) is fitted with the individual dialogue preparation (30) and the communication to the exercise and learning device (3, 3.1, 3.2, . . . 3.n) and to the communications server (5),
c) the entertainment region (21) is fitted with access to films (34), to music (35), to games (36) and to the internet (37),
d) the emergency region (22) is fitted with emergency information (32) and emergency numbers (33).

12. Exercise and learning concept for use of an exercise and learning device (3) in offline mode, comprises at least one portable exercise and learning device (3, 3.1, 3.2, . . . 3.n), which has hardware and software which provide means for exercise and learning and which is fitted with a touch-sensitive display (17) for operation, characterized in that
a) at least one exercise and learning module (8, 9, 10, 11, 12, 13) is generated on an input device (2, 2.1, 2.2, . . . 2.m),
b) an exercise and learning device (3, 3.1, 3.2, . . . 3.n) which comprises a communication device (15),
c) the communication device (15) which comprises an exercise and learning region (18), a system region (19), an information region (20), an entertainment region (21), an emergency region (22) and a program assistance region (23), as well as a function by which means an interactive connection can be made to the input device (2, 2.1, 2.2, . . . 2.m), can be transmitted via the exercise and learning module from an input device (2, 2.1, 2.2, . . . 2.m) to an exercise and learning device (3, 3.1, 3.2, . . . 3.n) and the monitoring protocol (8P, 9P, 10P, 11P, 12P, 13P) can be transmitted from the exercise and learning device (3, 3.1, 3.2, . . . 3.n) to an input device (2, 2.1, 2.2, . . . 2.m),
d) the exercise and learning region (18) which comprise exercise and learning modules (8, 9, 10, 11, 12, 13),
e) the exercise and learning modules (8, 9, 10, 11, 12, 13) which comprise a speech module (8), a writing module (9), a text module (10), a picture module (11), a movement module (12) and a logic module (13),
f) the exercise and learning module (3) which comprises means for recording a monitoring protocol (8P, 9P, 10P, 11P, 12P, 13P).
